(19) United States
(12) Patent Application Publication
(10) Pub. No.: US 2008/0025395 A1
(43) Pub. Date: Jan. 31, 2008

(54) Method and Apparatus for Motion Estimation in a Video Encoder

(75) Inventors: Robert S. Nemiroff, Carlsbad, CA (US); Chanchal Chatterjee, San Diego, CA (US); Robert O. Eifrig, San Diego, CA (US); Michael A. Grossman, San Diego, CA (US); Vicky B. Kaku, San Diego, CA (US); Zdong Wang, San Diego, CA (US); James R. Heaton, Ramona, CA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/460,341

(22) Filed: Jul. 27, 2006

(51) Int. Cl. H04N 7/12

(52) U.S. Cl. 375/240.12; 375/240.26

(57) ABSTRACT

Method and apparatus for motion estimation in a video encoder is described. In one example, a motion estimator includes registers, first-in-first out (FIFO) logic, costing logic, and processing logic. The registers are configured to store an even field and an odd field of a current macroblock pair in a current frame in a video stream. The FIFO logic is configured to store a reference window of a reference frame in the video stream. The costing logic is configured to produce cost data. The processing logic is coupled to the registers, the FIFO logic, and the costing logic. The processing logic is configured to generate common sums of absolute differences (SADs) for the current macroblock pair, generate SADs for partitions of the current macroblock pair from combinations of the common SADs, and cost and minimize the SADs for the partitions.

### BACKGROUND OF THE INVENTION

1. Field of the Invention

The present invention relates to digital video coding and, more particularly, to a method and apparatus for motion estimation in a video encoder.

2. Description of the Background Art

Video compression is used in many current and emerging products, such as digital television set-top boxes (STBs), digital satellite systems (DSSs), high definition television (HDTV) decoders, digital versatile disk (DVD) players, video conferencing, Internet video and multimedia content, and other digital video applications. Without video compression, digital video content can be extremely large, making it difficult or even impossible for the digital video content to be efficiently stored, transmitted, or viewed.

There are numerous video coding methods that compress digital video content. Consequently, video coding standards have been developed to standardize the various video coding methods so that the compressed digital video content is rendered in formats that a majority of video decoders can recognize. For example, the Motion Picture Experts Group (MPEG) and International Telecommunication Union (ITU-T) have developed video coding standards that are in wide use. Examples of these standards include the MPEG-1, MPEG-2, MPEG-4, ITU-T H.261, and ITU-T H.263 standards. The MPEG-4 Advanced Video Coding (AVC) standard (also known as MPEG-4, Part 10) is a newer standard jointly developed by the International Organization for Standardization (ISO) and ITU-T. The MPEG-4 AVC standard is published as ITU-T H.264 and ISO/IEC 14496-10. For purposes of clarity, MPEG-4 AVC is referred to herein as H.264.

Most modern video coding standards, such H.264, are based in part on a temporal prediction with motion compensation (MC) algorithm. Temporal prediction with motion compensation is used to remove temporal redundancy between successive pictures in a digital video broadcast. The temporal prediction with motion compensation algorithm includes a motion estimation (ME) algorithm that typically utilizes one or more reference pictures to encode a particular picture. A reference picture is a picture that has already been encoded. By comparing the particular picture that is to be encoded with one of the reference pictures, the temporal prediction with motion compensation algorithm can take advantage of the temporal redundancy that exists between the reference picture and the particular picture that is to be encoded and encode the picture with a higher amount of compression than if the picture were encoded without using the temporal prediction with motion compensation algorithm.

Motion estimation in an encoder is typically a computationally intensive process. Various techniques for motion estimation are known, including the so called “hierarchical search” and “diamond search” ME algorithms. While such techniques reduce processing requirements, they are notorious for finding false minimums (i.e., not identifying the best motion vector). Accordingly, there exists a need in the art for an improved method and apparatus for motion estimation in a digital video encoder.

### SUMMARY OF THE INVENTION

Method and apparatus for motion estimation in a video encoder is described. In one embodiment, a motion estimator includes registers, first-in-first out (FIFO) logic, costing logic, and processing logic. The registers are configured to store an even field and an odd field of a current macroblock pair in a current frame in a video stream. The FIFO logic is configured to store a reference window of a reference frame in the video stream. The costing logic is configured to produce cost data. The processing logic is coupled to the registers, the FIFO logic, and the costing logic. The processing logic is configured to generate common sums of absolute differences (SADs) for the current macroblock pair, generate SADs for partitions of the current macroblock pair from combinations of the common SADs, and cost and minimize the SADs for the partitions.

### BRIEF DESCRIPTION OF DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting an example of a video encoder in which one or more embodiments of the invention may be utilized;

FIG. 2 is a block diagram depicting an exemplary embodiment of the motion estimation module in accordance with one or more aspects of the invention;

FIG. 3 is a block diagram depicting an exemplary embodiment of a full pel motion estimation (FPME) module in accordance with one or more aspects of the invention;

FIG. 4 is a block diagram depicting an exemplary embodiment of processing logic in the FPME of FIG. 3 constructed in accordance with one or more aspects of the invention;

FIG. 5 is a chart illustrating a coordinate space for a 16×8 half-horizontal resolution (HHR) pixel array;

FIG. 6 is a chart illustrating a coordinate space for partitions of a 16×8 HHR pixel array;

FIG. 7 is a block diagram depicting an exemplary embodiment of a dual spiral cylinder in accordance with one or more aspects of the invention;

FIG. 8 is a flow diagram depicting an exemplary embodiment of a method for motion estimation in a video encoder in accordance with one or more aspects of the invention; and

FIG. 9 is a flow diagram depicting another exemplary embodiment of a method for motion estimation in a video encoder in accordance with one or more aspects of the invention.

To facilitate understanding, identical reference numerals have been used, where possible, to designate identical elements that are common to the figures.

### DETAILED DESCRIPTION OF THE INVENTION

Method and apparatus for motion estimation in a video encoder is described. One or more aspects of the invention relate to video coding compliant with the H.264 video coding standard. The documents establishing the AVC/H.264 video coding standard, namely ITU-T Rec. H.264 | ISO/IEC 14496-10 version 4 (1 Mar. 2005), are incorporated by reference herein. Although the present method and apparatus for motion estimation is compatible with and will be explained using H.264 standard guidelines, those skilled in the art will appreciate that the motion estimation of the present invention may be modified and used as best serves a particular standard or application.

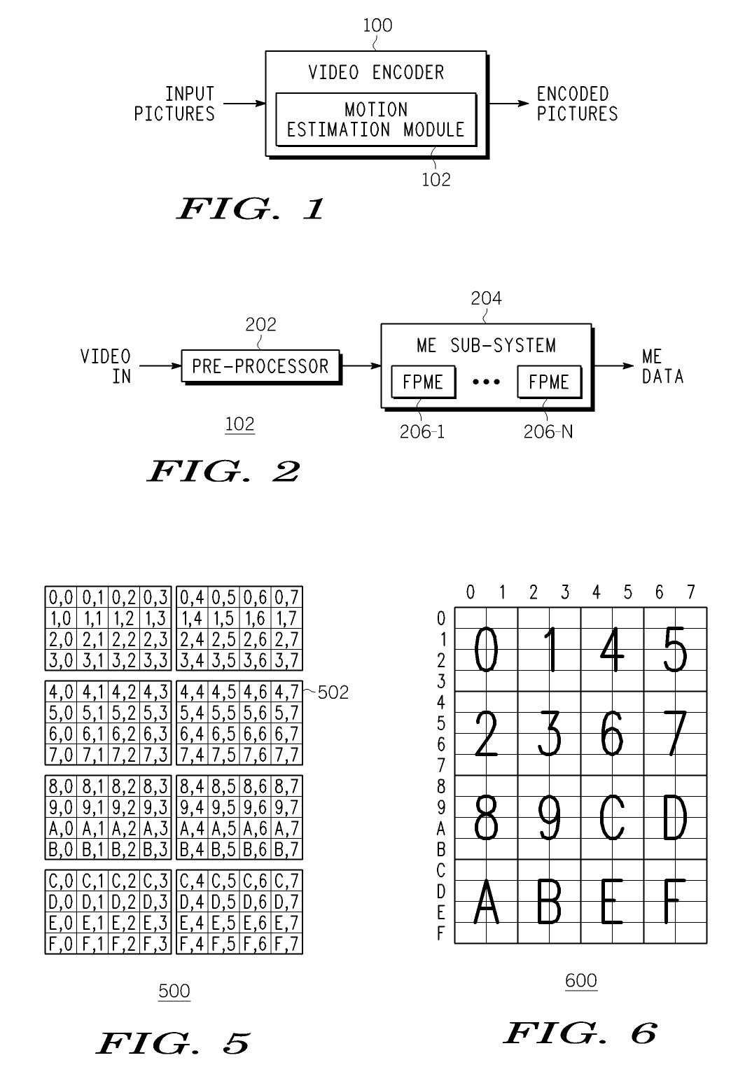

FIG. 1 is a block diagram depicting an example of a video encoder 100 in which one or more embodiments of the invention may be utilized. For example, the video encoder may be an H.264 video encoder. The video encoder 100 receives video data to be encoded and generates encoded video. The video to be encoded comprises a series of pictures, and the video encoder 100 generates a series of encoded pictures. A picture might be, for example, a frame of non-interlaced video, a frame of interlaced video, a field of interlaced video, etc. Each input picture comprises an array of pixels, and each pixel is typically represented as an unsigned character, typically using eight bits. The input video data is digitized and represented as luminance (luma) and two color difference signals (Y, Cᵣ, and C_{b}). The input video may have either a high definition (HD) format or standard definition (SD) format. The video encoder 100 includes a motion estimation module 102. The motion estimation module 102 is configured to generate motion vector data. As is well known in the art, the motion vectors are used in the video coding process and are combined with the coded video as output of the video encoder 100. Various components of the video encoder 100 have been omitted for clarity. Such components and their operation within the video encoder 100 are well known in the art.

FIG. 2 is a block diagram depicting an exemplary embodiment of the motion estimation module 102 in accordance with one or more aspects of the invention. The motion estimation module 102 includes a pre-processor 202 and a motion estimation (ME) sub-system 204. An input interface of the pre-processor 202 receives the video data. The pre-processor 202 is configured to synchronize the input video data. The pre-processor 202 drops the chroma data and only passes the luma data to the ME sub-system 204. In one embodiment, the pre-processor 202 is further configured to horizontally decimate the video data. Horizontal decimation provides for increased computational efficiency in the ME sub-system. The pre-processor 202 provides half-horizontal resolution (HHR) video data to the ME sub-system 204. Alternatively, horizontal decimation may be omitted and the pre-processor 202 may provide full resolution video data to the ME sub-system 204. For purposes of clarity by example, the invention is described below with respect to horizontally decimated video data. The ME sub-system 204 is configured to process the HHR video data to produce ME data. The ME sub-system 204 includes full pel motion estimation (FPME) modules 206-1 through 206-N, where N is an integer greater than zero. Each of the FPME modules 206 is configured to perform full pel motion estimation between a reference picture and a current picture.

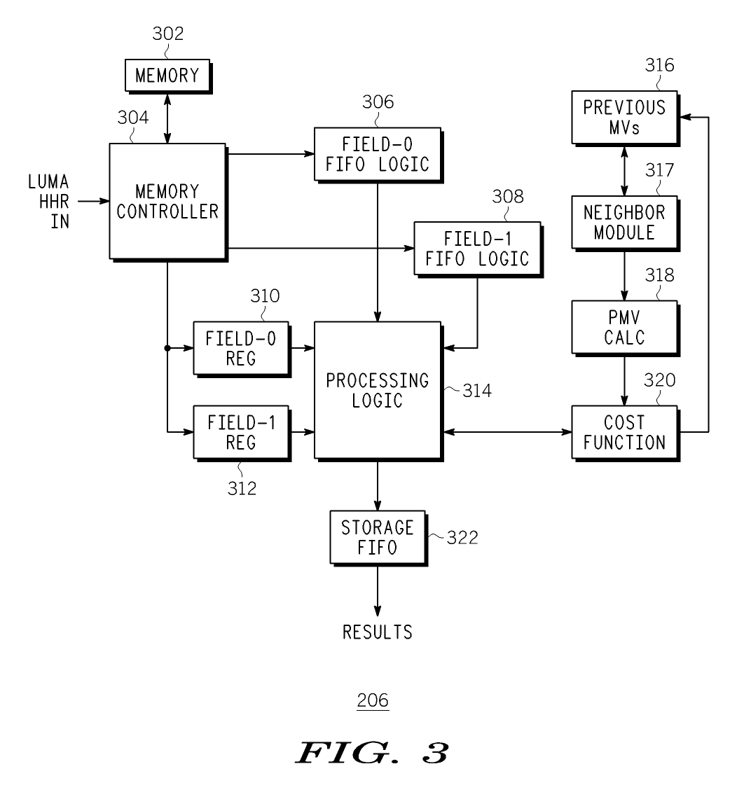

FIG. 3 is a block diagram depicting an exemplary embodiment of a FPME module 206 in accordance with one or more aspects of the invention. The FPME module 206 includes a memory 302, a memory controller 304, field-0 first in first out (FIFO) logic 306, field-1 FIFO logic 308, a field-0 register 310, a field-1 register 312, processing logic 314, previous MV storage 316, PMV calculation module 318, cost function module 320, neighbor module 317, and storage FIFO 322. The memory controller 304 is configured to receive luma HHR data from the pre-processor 202. In the present embodiment, motion estimation is performed on the luminance signal in the input video. The memory controller 304 is configured to store luma HHR frames (referred hereinafter as frames) in the memory 302. In one embodiment, the frames are stored in interlaced format and the FPME module 206 performs computations in the interlaced domain. Although the invention is described below with respect to interlaced-domain computations, those skilled in the art will appreciate that the FPME module 206 may be adapted to perform computations in the non-interlaced domain (e.g., for non-interlaced input video).

Each of the frames is formed of macroblocks of pixels. Each macroblock in a frame includes a 16×8 pixel region. Each reference to pixel dimensions herein includes the vertical pixels first followed by the horizontal pixels (V×H) and is in HHR terms unless otherwise indicated. When discussing H.264 terms, the horizontal dimension should be multiplied by two (i.e., in H.264 terms, each macroblock includes a 16×16 pixel region). Each macroblock comprises two interlaced fields: field-0 (also referred to as the even field) and field-1 (also referred to as the odd field). Each field in a single macroblock includes an 8×8 pixel region. As described below, the FPME module 206 processes the macroblocks of a current frame in vertical pairs. Each macroblock pair includes a 32×8 pixel region. Thus, each field of a macroblock pair includes a 16×8 pixel region. In frame terms, each macroblock pair can be divided into a frame top having 16×8 pixels and a frame bottom having 16×8 pixels.

The FPME module 206 performs a full search across a search region in a reference frame (“reference window”). In one embodiment, the reference window comprises a 128×128 pixel region. In general, the motion vector search for a current macroblock pair begins by placing the macroblock pair at the top left corner of the reference window and performing pixel-for-pixel subtractions. The pixel differences are used to compute various sums of absolute differences (SADs). The computed SADs are minimized to produce motion vector data for the current macroblock pair. The current macroblock pair is then shifted one pixel to the right and the process is repeated across all 128 horizontal pixel locations of the reference window. Then the current macroblock is shifted down one line and the process is repeated for all lines of the reference window.

In particular, the memory controller 304 retrieves macroblock pair of a current frame. The memory controller 304 loads field-0 of the macroblock pair into the register 310 and field-1 of the macroblock pair into the register 312. The memory controller 304 retrieves pixels of the reference window from the memory 302 and loads the pixels for field-0 of the reference window in the field-0 FIFO logic 306, and the pixels for field-1 of the reference window in the field-1 FIFO logic 308. Each of the field-0 FIFO logic 306 and the field-1 FIFO logic 308 is initialized such that the current macroblock pair is placed in the top left corner of the reference window. The memory controller 304 pushes new pixel data into the FIFO logic 306 and the FIFO logic 308 to effectively shift the current macroblock pair within the reference window.

The processing logic 314 is coupled to the field-0 register 310, the field-1 register 312, the field-0 FIFO logic 306, and the field-1 FIFO logic 308, and the cost function module 320. The processing logic 314 is configured to compute SADs and motion vector data for the current macroblock pair. In particular, the processing logic 314 computes pixel differences separately between field-0 of the current macroblock pair and field-0 of the reference window (“field-0 even”), field-1 of the current macroblock pair and field-0 of the reference window (“field-1 odd”), field-0 of the current macroblock pair and field-1 of the reference window (“field-0 odd”), and field-1 of the current macroblock pair and field-1 of the reference window (“field-1 even”). The terms “even” and “odd” refer to the parity. Even parity denotes field-0 and/or field-1 lines of the current macroblock compared with field-0 and/or field-1 lines of the reference window, respectively. Odd parity denotes field-0 and/or field-1 lines of the current macroblock compared with field-1 and/or field-0 lines of the reference window, respectively.

From the pixel differences, the processing logic 314 computes SADs for each of field-0 even, field-0 odd, field-1 even, and field-1 odd comparisons (“field SADs”). The processing logic 314 uses the field SADs to compute SADs for frame top even, frame top odd, frame bottom even, and frame bottom odd comparisons (“frame SADs”). The field SADs are costed and minimized to produce motion vector data for field-0 and field-1 of the current macroblock pair. The frame SADs are costed and minimized to produce motion vector data for the top frame and the bottom frame of the current macroblock pair.

In H.264, a macroblock can be partitioned into smaller block sizes. For example, a macroblock can be divided into sixteen 4×4 partitions, eight 4×8 partitions, eight 8×4 partitions, four 8×8 partitions, two 8×16 partitions, two 16×8 partitions, and one 16×16 partition for a total of 41 partitions per macroblock. Motion estimation in H.264 allows for referencing these partitions when computing motion vectors. In one embodiment, the processing logic 314 is configured to compute SADs for each of the partitions in the current macroblock pair. Alternatively, the processing logic 314 may be configured to process a subset of the partitions, which reduces the clock speed and data bandwidth requirements. For example, the processing logic 314 may be configured to process only the 8×8, 8×16, 16×8, and 16×16 partitions for a total of nine partitions per macroblock. The processing logic 314 generates six motion vectors and associated costed SADs for each partition (i.e., motion vectors and costed SADs for field-0 ever, field-0 odd, field-1 even, field-1 odd, frame top, and frame bottom for each partition). The output of the processing logic 314 is stored in the storage FIFO 322. The processing is repeated for additional macroblock pairs in the current frame and for additional frames.

In one embodiment, data is reloaded into the field-0 FIFO logic 306 and the field-1 FIFO logic 308 for each macroblock pair to allow a new center for each reference window. Alternatively, the reference window data is not reloaded. Rather, additional pixels for the next macroblock pair reference window are shifted into the field-0 and field-1 FIFO logic 306 and 308, keeping the center of the search window the same relative to each macroblock pair. While this increases design efficiency, the search area is limited.

Each SAD computed by the processing logic 314 is “costed” by adding a cost computed by the cost function 320. The cost function 320 implements the following:

$$λ * ( selen ( 8 * ( MVx - PMVx ) ) + selen ( 4 * ( MVy - PMVy ) ) )$$

$$selen ( x ) = \{ \begin{matrix}1 & if x == 0 \\ 2 ⌊ {log}_{2} \vert x \vert ⌋ + 3 & if x \neq 0\end{matrix} ,$$

where MVx and MVy are x and y components, respectively, of the motion vector for the SAD, PMVx and PMVy are x and y components, respectively, of the median of motion vectors of neighboring macroblock pairs, selen is the signed exponential Golomb length, and λ is a constant for the entire current frame. In one embodiment, PMV may be computed from any combination of the neighbor motion vectors. The cost function 320 computes a cost for frame top, frame bottom, field 0, and field 1. In addition, the constant λ may be dynamically selected based on the partition associated with the SAD that is being costed (e.g., there may be different λ constants for 4×4 SADs, 4×8 SADs, 8×8 SADs, etc.). In one embodiment, λ may be different for each macroblock pair based on several factors, such as macroblock relative spatial activity and quantization level. The neighbor module 317 is configured to select previous motion vector(s) (if any) from the storage 316, and the PMV calculation module 318 is configured to compute the median of the retrieved motion vector(s) (if any) to compute the PMV.

In particular, previous motion vectors are stored in the previous MV storage 316. Given a current macroblock pair, the neighbor module 317 determines which, if any, previous motion vectors should be included in the median calculation for the frame top, frame bottom, field-0, and field-1 PMVs. Assume the selectable neighbors for a current macroblock pair are designated north, northeast, northwest, and west. The north neighbor is above, the northeast neighbor is above and to the right, the northwest neighbor is above and to the left, and the west neighbor is to the left of the current macroblock pair. If the current macroblock pair is from the top left corner of the frame, then it is the first macroblock pair processed and thus there are no previous motion vectors in the storage 316. The PMVs are zero.

If the current macroblock pair is from the top edge of the frame (other than the top left corner), then the neighbor module 317 retrieves previous motion vector data associated with the west neighbor. The PMVs are the previous motion vectors for frame top, frame bottom, field-0, and field-1 for the west neighbor. If the current macroblock pair is from the left edge of the frame (other than the top left corner), then the neighbor module 317 retrieves previous motion vector data associated with the north neighbor and the northeast neighbor. The frame top PMV is the median of the frame top motion vectors of the north and northeast neighbors, the frame bottom PMV is the median of the frame bottom motion vectors of the north and northeast neighbors, the field-0 PMV is the median of the field-0 motion vectors of the north and northeast neighbors, and the field-1 PMV is the median of the field-1 motion vectors of the north and northeast neighbors.

If the current macroblock pair is from the right edge of the frame (other than the top right corner), then the neighbor module 317 retrieves previous motion vector data associated with the west, north, and northwest neighbors. Each type of PMV is the median of the like type of previous motion vectors of the west, north, and northwest neighbors. For every other macroblock pair in the frame, the neighbor module 317 retrieves previous motion vector data associated with the west, north, and northeast neighbors. Each type of PMV is the median of the like types of previous motion vectors of the west, north, and northeast neighbors. The previous motion vector storage 316, the neighbor module 317, the PMV calculation module 318, and the cost function 320 are generally referred to as costing logic. The cost function 320 is also configured to store at least a portion of the motion vectors produced by the processing logic 314 in the previous motion vector storage 316.

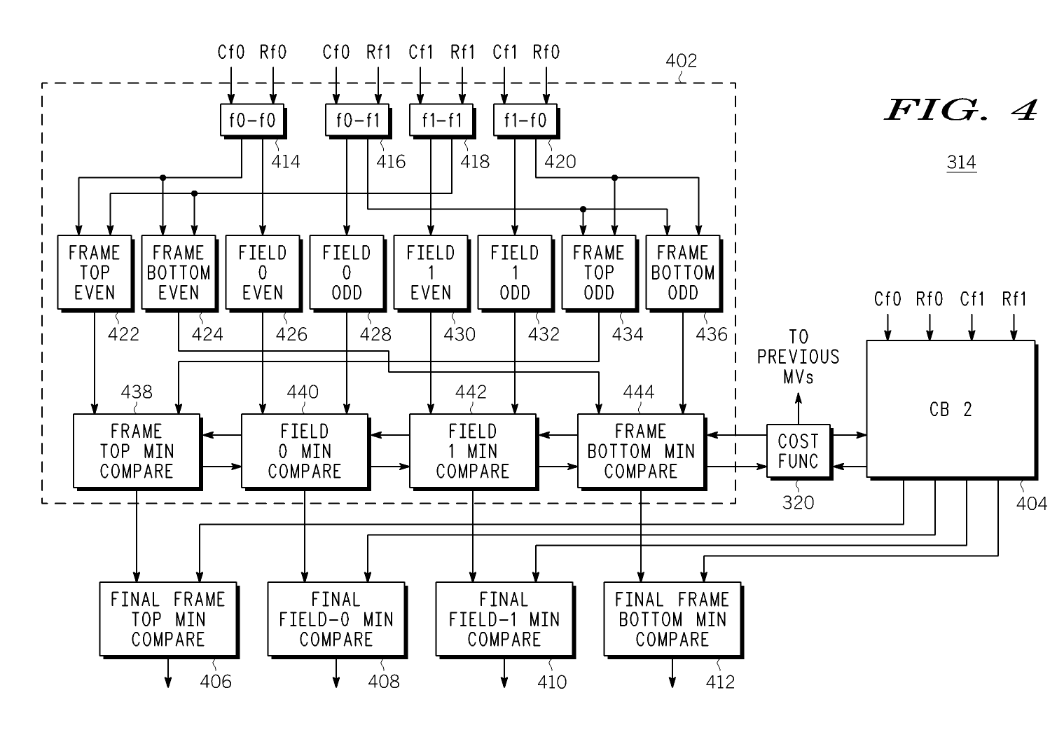

FIG. 4 is a block diagram depicting an exemplary embodiment of the processing logic 314 constructed in accordance with one or more aspects of the invention. The processing logic 314 includes a computation block 402, a computation block 404, and minimum compare modules 406, 408, 410, and 412. Each of the computation blocks 402 and 404 is coupled to the field-0 and field-1 registers 310 and 312, as well as the field-0 and field-1 FIFO logic 306 and 308. Each of the computation blocks is also coupled to the cost function module 320. Each of the computation blocks 402 and 404 includes identical logic. For purposes of clarity, only the computation block 402 is shown in detail.

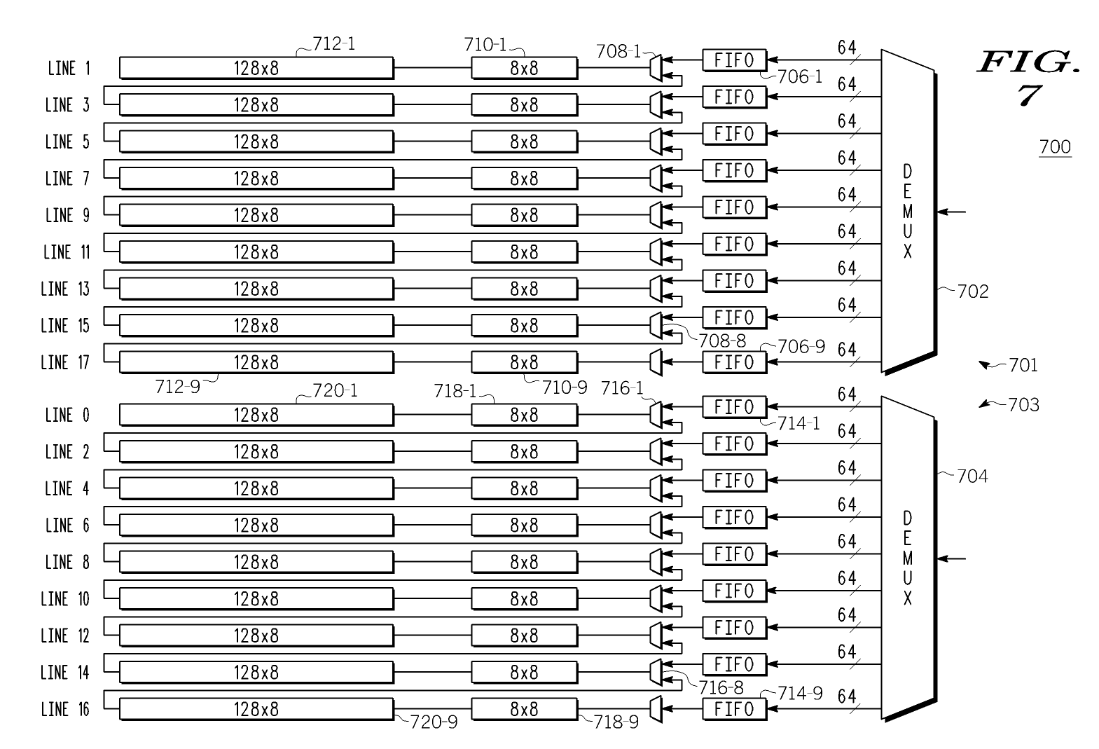

The computation block 402 includes common sum modules 414 through 420, SAD modules 422 through 436, and compare modules 438 through 444. Aspects of operation for the computation block 402 may be understood with respect to FIGS. 5-6. FIG. 5 is a chart illustrating a coordinate space 500 for a 16×8 HHR pixel array. The coordinate space 500 may represent an even or odd field or a top or bottom frame. The pixel columns range from 0 through 7. The pixel rows range from 0 through 9 and A through F (where A is the 10^{th} row, B is the 11^{th} row and so on until F is the 15^{th} row). Each pixel can be represented by an ordered pair in the form of (row, column). For example, the pixel 502 has a coordinate of (4,7). FIG. 6 is a chart illustrating a coordinate space 600 for partitions of a 16×8 HHR pixel array. The coordinate space 600 may represent an even or odd field or a top or bottom frame. Each 4×4 partition is designated by a reference character ranging from 0 through 9 and A through F for a total of sixteen 4×4 partitions. Other partitions may be designated by combining the designations of the 4×4 partitions. For example, an 8×8 partition may be designated as 0-1-2-3, a 16×8 partition may be designated as 4-5-6-7-C-D-E-F, and so on.

The basic building block for computing a SAD is a SAD of two pixels, which is defined as:

|REF_{m,n}−CMB_{m,n}|+|REF_{m,n+1}−CMB_{m,n+1}|,

where REF denotes the reference window, CMB denotes the current macroblock (a 16×8 HHR pixel region), and m and n denote pixel locations in the coordinate space 500. Summing two 2-pixel SADs yields a SAD for a 2×4 region (non-HHR). A SAD for a 4×4 partition (e.g., partition 0) can be computed by summing two 2×4 region SADs. Likewise, a SAD for an 8×8 partition (e.g., partition 0-1-2-3) can be computed by summing eight 2×4 region SADs and so on for other partition types.

In general, each of the 4×4, 4×8, 8×4, 8×8, 8×16, 16×8, and 16×16 partitions of an even/odd field can be computed by summing a combination of 2×4 region SADs for that even/odd field. In addition, each of the 4×4, 4×8, 8×4, 8×8, 8×16, 16×8, and 16×16 partitions of a top/bottom frame can be computed by summing a combination of 2×4 region SADs for both even and odd fields. For example, a SAD for a 4×4 partition in a top or bottom frame can be computed by summing a 2×4 region SAD of field-0 with a 2×4 region SAD of field-1. For this reason, if the processing logic 314 is configured to process all of the partition types, the 2×4 region SAD for a field can be considered to be a “common sum”. As discussed above, in some embodiments, not every partition type is processed. For example, in one embodiment, only the 8×8, 8×16, 16×8, and 16×16 partitions are processed. In such a case, a 4×8 region SAD is a common sum. For a field, SADs for the 8×8, 8×16, 16×8, and 16×16 partitions can be computed by summing combinations of the 4×8 region SADs. For a frame, SADs for the 8×8, 8×16, 16×8, and 16×16 partitions can be computed by summing combinations of the 4×8 region SADs for field-0 and field-1.

The common sum module 414 (“f0-f0 module”) computes common sums for current field-0 (Cf0) and reference field-0 (Rf0). The common sum module 416 (“f0-f1 module”) computes common sums for current field-0 and reference field-1 (Rf1). The common sum module 418 (“f1-f1 module”) computes common sums for current field-1 (Cf1) and reference field-1. The common sum module 420 (“f1-f0 module”) computes common sums for current field-1 and reference field-0.

The SAD module 422 (“frame top even”) receives common sums from the f0-f0 and f1-f1 modules 414 and 418 and computes SADs for partitions in the top frame with even parity. The SAD module 424 (“frame bottom even”) receives common sums from the f0-f0 and f1-f1 modules 414 and 418 and computes SADs for partitions in the bottom frame with even parity. The SAD module 426 (“field-0 even”) receives common sums from the f0-f0 module 414 and computes SADs for the partitions in field-0 with even parity. The SAD module 428 (“field-0 odd”) receives common sums from the f0-f1 module 416 and computes SADs for the partitions in field-0 with odd parity. The SAD module 430 (“field-1 even”) receives common sums from the f1-f1 module 418 and computes SADs for the partitions in field-1 with even parity. The SAD module 432 (“field-1 odd”) receives common sums from the f1-f0 module 420 and computes SADs for the partitions in field-1 with odd parity. The SAD module 434 (“frame top odd”) receives common sums from the f0-f1 and f1-f0 modules 416 and 420 and computes SADs for the partitions in the top frame with odd parity. The SAD module 436 (“frame bottom odd”) receives common sums from the f0-f1 and f1-f0 modules 416 and 420 and computes SADs for the partitions in the bottom frame with odd parity. The SAD modules 422 through 436 may compute SADs for all partitions or less than all partitions, as discussed above.

The compare module 438 (“frame top compare module”) receives SADs from the frame top even SAD module 422 and the frame top odd SAD module 434. The compare module 438 also receives cost data from the cost function 320. The compare module 438 performs a two stage compare for each partition type: First, for each partition type, the frame top compare module 438 adds the associated costs to the SADs and compares the costed frame top even SAD with the costed frame top odd SAD to select a minimum frame top SAD. For each partition type, the compare module 438 maintains a running minimum costed SAD for all shifts of the current macroblock pair in the reference window. In the second stage, for each partition type, the frame top compare module 438 compares the minimum frame top SAD obtained from the first stage with the running minimum. If a new running minimum is found and stored, the motion vector associated with that new minimum is also stored.

The compare module 440 (“field-0 compare module”) receives SADs from the field-0 even SAD module 426 and the field-0 odd SAD module 428. The compare module 440 also receives cost data from the cost function 320. The compare module 440 performs a two stage compare for each partition type, similar to the frame top compare module 438. First, for each partition type, the field-0 compare module 440 adds the associated costs to the SADs and compares the costed field-0 even SAD with the costed field-0 odd SAD to select a minimum field-0 SAD. Second, for each partition type, the field-0 compare module 440 compares the minimum field-0 SAD obtained from the first stage with the running minimum. If a new running minimum is found and stored, the motion vector associated with that new minimum is also stored. In another embodiment, the field-0 even and field-0 odd results have separate compare modules.

The compare module 442 (“field-1 compare module”) receives SADs from the field-1 even SAD module 430 and the field-1 odd SAD module 432. The compare module 442 also receives cost data from the cost function 320. Again, the compare module 442 performs a two stage compare for each partition type. First, for each partition type, the field-1 compare module 442 adds the associated costs to the SADs and compares the costed field-1 even SAD with the costed field-1 odd SAD to select a minimum field-1 SAD. Second, for each partition type, the field-1 compare module 442 compares the minimum field-1 SAD obtained from the first stage with the running minimum. If a new running minimum is found and stored, the motion vector associated with that new minimum is also stored. In another embodiment, the field-1 even and field-1 odd results have separate compare modules.

The compare module 444 (“frame bottom compare module”) receives SADs from the frame bottom even SAD module 424 and the frame bottom odd SAD module 436. The compare module 444 also receives cost data from the cost function 320. The compare module 444 performs a two stage compare for each partition type. First, for each partition type, the frame bottom compare module 444 adds the associated costs to the SADs and compares the costed frame bottom even SAD with the costed frame bottom odd SAD to select a minimum frame bottom SAD. Second, for each partition type, the frame bottom compare module 440 compares the minimum frame bottom SAD obtained from the first stage with the running minimum. If a new running minimum is found and stored, the motion vector associated with that new minimum is also stored.

The minimum compare module 406 (“final frame top”) receives, for each partition, a minimum SAD and associated motion vector from the frame top compare module 438 in each of the computation blocks 402 and 404. The final frame top compare module 406 compares the results from the two computation blocks 402 and 404 and selects the minimum as the final frame top SAD. The minimum compare module 408 (“final field-0”) receives, for each partition, a minimum SAD and associated motion vector from the field-0 compare module 440 in each of the computation blocks 402 and 404. The final field-0 compare module 408 compares the results from the two computation blocks 402 and 404 and selects the minimum as the final field-0 SAD. The minimum compare module 410 (“final field-1”) receives, for each partition, a minimum SAD and associated motion vector from the field-1 compare module 442 in each of the computation blocks 402 and 404. The final field-1 compare module 410 compares the results from the two computation blocks 402 and 404 and selects the minimum as the final field-1 SAD. The minimum compare module 412 (“final frame bottom”) receives, for each partition, a minimum SAD and associated motion vector from the frame bottom compare module 444 in each of the computation blocks 402 and 404. The final frame bottom compare module 406 compares the results from the two computation blocks 402 and 404 and selects the minimum as the final frame bottom SAD. In this manner, the processing logic 314 generates costed SADs and motion vectors for partitions in frame top, frame bottom, field-0, and field-1 of the current macroblock pair. The processing logic 314 repeats the operation described above for additional macroblock pairs in the current frame, and then for additional frames in the input video.

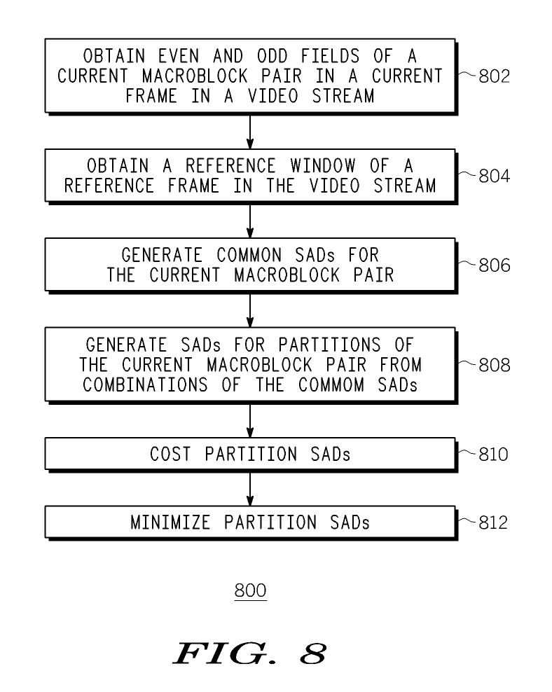

FIG. 8 is a flow diagram depicting an exemplary embodiment of a method 800 for motion estimation in a video encoder in accordance with one or more aspects of the invention. The method 800 begins at step 802, where even and odd fields of a current macroblock pair in a current frame in a video stream are obtained. At step 804, a reference window of a reference frame in the video stream is obtained. At step 806, common SADs for the current macroblock pair are generated. At step 808, SADs for partitions of the current macroblock pair are generated from combinations of the common SADs. At step 810, the partition SADs are costed. At step 812, the partition SADs are minimized. The method 800 may be repeated for various positions of the current macroblock pair within the reference window. In this manner, costed SADs and motion vectors may be produced for the current macroblock pair.

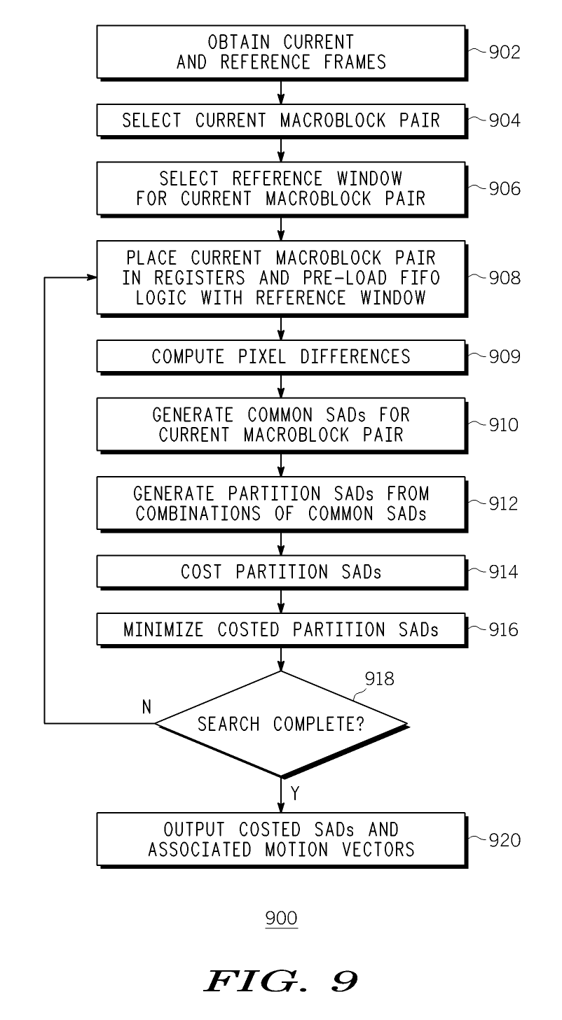

FIG. 9 is a flow diagram depicting another exemplary embodiment of a method 900 for motion estimation in a video encoder in accordance with one or more aspects of the invention. The method 900 begins at step 902, where a current frame and a reference frame in a video stream are obtained. At step 904, a current macroblock pair is selected in the current frame. At step 906, a reference window in the reference frame is selected for the current macroblock pair. At step 908, the current macroblock is placed in registers and FIFO logic is pre-loaded with the reference window. At step 909, the pixel differences are computed. Pixel differences are computed between both even fields, both odd fields, the even field and odd field, and the odd field and the even field of the current macroblock pair and the reference window. At step 910, common SADs are generated for the current macroblock pair. Common SADs are generated for the even/even, odd/odd, even/odd, and odd/even pixel differences between the even field of the current macroblock pair and the reference window.

At step 912, partition SADs are generated for the current macroblock pair from combinations of the common SADs. As discussed above, SADs can be computed for all or a subset of partitions for frame top, frame bottom, even field, and odd field of the current macroblock pair for both even and odd parity with respect to the reference window. At step 914, the partition SADs are costed. At step 916, the costed partition SADs are minimized. Notably, like-type partition SADs are minimized for each of frame top, frame bottom, even field, and odd field as between even and odd parity. The results are then compared against running minimum partition SADs to determine if new minimums have been found.

At step 918, a determination is made whether the search has been completed. If not, the method 900 continues to step 919, where the reference window FIFO logic is shifted. The method 900 returns to step 909, where new pixel differences are computed. If the search is complete, the method 900 proceeds from step 918 to step 920. At step 920, costed SADs and associated motion vectors are output for all or a subset of partitions of top frame, bottom frame, even field, and odd fields of the current macroblock pair. The method 900 may be repeated for each macroblock pair in the current frame, and for multiple frames.

FIG. 7 is a block diagram depicting an exemplary embodiment of a dual spiral cylinder 700 in accordance with one or more aspects of the invention. Each of the field-0 FIFO logic 306 and the field-1 FIFO logic 308 of FIG. 2 may comprise a dual spiral cylinder 700. The dual spiral cylinder 700 includes a first spiral cylinder 701 and a second spiral cylinder 703. The spiral cylinder 701 includes a demultiplexer 702, FIFOs 706-1 through 706-9, multiplexers 708-1 through 708-8, registers 710-1 through 710-9, and FIFOs 712-1 through 712-9. The spiral cylinder 703 includes a demuiltiplexer 704, FIFOs 714-1 through 714-9, multiplexers 716-1 through 716-8, registers 718-1 through 718-9, and FIFOs 720-1 through 720-9.

The demultiplexer 702 includes a single input terminal and nine output terminals. The output terminals of the demultiplexer 702 are coupled to input terminals of the FIFOs 706, respectively. The output of the FIFO 706-9 is coupled to an input of the register 710-9. Each of the multiplexers 708 includes two input terminals and one output terminal. The FIFOs 706-1 through 706-8 are coupled to first input terminals of the multiplexers 708-1 through 708-8, respectively. Output terminals of the registers 710 are coupled to input terminals of the FIFOs 712. An output terminal of the FIFO 712-9 is coupled to the second input terminal of the multiplexer 708-8; an output terminal of the FIFO 712-8 is coupled to the second input terminal of the multiplexer 708-7; an output terminal of the FIFO 712-7 is coupled to the second input terminal of the multiplexer 708-6; and so on until the output terminal of the FIFO 712-2 is coupled to the second input terminal of the multiplexer 708-1. The input terminal and output terminals of the demultiplexer 702 are 64 bits (8 bytes) wide. The input terminals of the FIFOs 706 are 8 bytes wide. The output terminals of the FIFOs 706 are one byte wide. The FIFOs 706 are 32 bytes deep. The input and output terminals of the multiplexers 708, the registers 710, and the FIFOs 712 are one byte wide. The registers 710 are configured to store 8 bytes. The FIFOs 712 are 128 bytes deep. The demultiplexer 704, the FIFOs 714, the multiplexers 716, the registers 718, and the FIFOs 720 are configured identically to the demultiplexer 702, the FIFOs 706, the multiplexers 708, the registers 710, and the FIFOs 712.

As described above, the motion vector search is performed starting at the top left corner of the reference window and proceeds across 128 locations for each of the 64 field lines. The dual spiral cylinder 700 includes a 128 byte deep secondary stage FIFO (i.e., FIFOs 712 and FIFOs 720). Each of the FIFOs 712 and 720 represent one line of the reference window, 128 pixels across (each pixel is assumed to be one byte). The FIFOs 712 represent odd lines 1 through 17, and the FIFOs 720 represent even lines 0 through 16. That is, odd lines are stored in the spiral cylinder 701 and even lines are stored in the spiral cylinder 703. The registers 710 and 718 represent data accessible for SAD calculations. That is, the registers 710 store an 8×18 pixel array. The first stage FIFO (i.e., FIFOs 706 and 714) provide a buffer between the memory controller 304 and the registers 710 and 718. The input terminals of the demultiplexers 702 and 704 are configured to receive data from the memory controller 304. The multiplexers 708 and 716 allow for two modes of operation: parallel load and spiral load.

In the parallel load mode, data is gathered from the memory 302 in chunks of 32 byte bursts. Each burst represents a single line of 32 bytes (32 pixels). The first burst is stored into the FIFO 714-1, after which data is sent byte-wide serially through the register 718-1, where the data is stored. The next line is read in a similar fashion and so on for lines 0 through 17. Each even line read is stored into the spiral cylinder 701, while each odd line read is stored into the spiral cylinder 703. The dual spiral cylinder 700 stores data for one field. Another dual spiral cylinder stores data for the other field.

Once all 18 lines have been loaded for 32 pixels each, SAD calculations can begin. Since there are two spiral cylinders 701 and 703, SADs can be calculated for line 0, as well as line 1. While the first set of SADs is being calculated, another chunk of 18×32 bytes of data are collected to continue the process. Pixels are shifted into the register array (registers 710 and 718), after which data is shifted into the secondary stage FIFO (FIFOs 712 and 720). This process continues until the entire secondary stage FIFO is full. This mode of operation is effectively parallel loading of the secondary stage FIFO.

The next stage of data collection changes data loading to only the bottom of the spiral cylinder 701 (the FIFO 706-9, the register 710-9, and the FIFO 712-9) and the bottom of the spiral cylinder 703 (the FIFO 714-9, the register 718-9, and the FIFO 720-9). All of the multiplexers 708 and 716 switch from the parallel data mode to the spiral mode. That is, in the parallel mode, the inputs of the multiplexers 708 and 716 that are coupled to the FIFOs 706 and 714 are selected. In the spiral mode, the inputs of the multiplexers 708 and 716 that are coupled to the FIFOs 712 and 720 are selected. In the spiral mode, the multiplexers 708 and 716 take data from the bottom most FIFO and feed the one above for every pixel data gathered from the memory 302. Since there are two spiral cylinders 701 and 703, 2 lines of data needs to be loaded for the given field. Data is loaded again in 32 byte chunks, first shifting in 8 pixels on the bottom spiral cylinder 703, then the top spiral cylinder 701. After these two lines are loaded, SAD calculations continue. For every pixel shifted, the spiral cylinders 701 and 703 move pixels up. The top of each spiral cylinder 701 and 703 drops the pixels that are not needed.

While the foregoing is directed to illustrative embodiments of the present invention, other and further embodiments of the invention may be devised without departing from the basic scope thereof, and the scope thereof is determined by the claims that follow.

What is claimed is:

1. Apparatus for motion estimation in a video encoder, comprising:
registers for storing an even field and an odd field of a current macroblock pair in a current frame in a video stream;
first-in-first-out (FIFO) logic for storing a reference window of a reference frame in the video stream;
costing logic for producing cost data; and
processing logic, coupled to the registers, the FIFO logic, and the costing logic, for generating common sums of absolute differences (SADs) for the current macroblock pair, generating SADs for partitions of the current macroblock pair from combinations of the common SADs, and costing and minimizing the SADs for the partitions.

2. The apparatus of claim 1, wherein the processing logic comprises:
common SAD modules for producing the common SADs;
partition SAD modules for producing the SADs for the partitions; and
compare modules for costing and minimizing the SADs for the partitions.

3. The apparatus of claim 2, wherein the common SAD modules comprise:
a first common SAD module for processing the even field of the current macroblock pair and an even field data of the reference window;
a second common SAD module for processing the even field of the current macroblock pair and an odd field data of the reference window;
a third common SAD module for processing the odd field of the current macroblock pair and the odd field data of the reference window; and
a fourth common SAD module for processing the odd field of the current macroblock pair and the even field data of the reference window.

4. The apparatus of claim 2, wherein the partition SAD modules comprise:
first and second partition SAD modules for producing even and odd parity partition SADs, respectively, for a top frame portion of the current macroblock pair;
third and fourth partition SAD modules for producing even and odd parity partition SADs, respectively, for the even field of the current macroblock pair;
fifth and sixth partition SAD modules for producing even and odd parity partition SADs, respectively, for the odd field of the current macroblock pair; and
seventh and eighth partition SAD modules for producing even and odd parity partition SADs, respectively, for a bottom frame portion of the current macroblock pair.

5. The apparatus of claim 2, wherein the compare modules comprise:
a first compare module for producing a minimum costed SAD and associated motion vector for the top frame portion of the current macroblock pair;
a second compare module for producing a minimum costed SAD and associated motion vector for the even field of the current macroblock pair;
a third compare module for producing a minimum costed SAD and associated motion vector for the odd field of the current macroblock pair; and
a fourth compare module for producing a minimum costed SAD and associated motion vector for the bottom frame portion of the current macroblock pair.

6. The apparatus of claim 1, wherein the processing logic comprises a first computation block and a second computation block.

7. The apparatus of claim 6, wherein the processing logic further comprises:
a first compare module for producing a minimum costed SAD and associated motion vector for a top frame portion of the current macroblock pair;
a second compare module for producing a minimum costed SAD and associated motion vector for the even field of the current macroblock pair;
a third compare module for producing a minimum costed SAD and associated motion vector for the odd field of the current macroblock pair; and
a fourth compare module for producing a minimum costed SAD and associated motion vector for a bottom frame portion of the current macroblock pair.

8. A method of motion estimation in a video encoder, comprising:
obtaining an even field and an odd field of a current macroblock pair in a current frame in a video stream;
obtaining a reference window of a reference frame in the video stream;
generating common sums of absolute differences (SADs) for the current macroblock pair;
generating SADs for partitions of the current macroblock pair from combinations of the common SADs;
costing the SADs for the partitions; and
minimizing the SADs for the partitions.

9. The method of claim 8, wherein:
a first portion of the common SADs correspond to pixel differences between the even field of the current macroblock pair and even field data of the reference window;
a second portion of the common SADs correspond to pixel differences between the even field of the current macroblock pair and odd field data of the reference window;
a third portion of the common SADs correspond to pixel differences between the odd field of the current macroblock pair and the odd field data of the reference window; and
a fourth portion of the common SADs correspond to pixel differences between the off field of the current macroblock pair and the even field data of the reference window.

10. The method of claim 8, wherein:
first and second portions of the partition SADs correspond to even and odd parity pixel differences, respectively, for a top frame portion of the current macroblock;
third and fourth portions of the partition SADs correspond to even and odd parity pixel differences, respectively, for the even field of the current macroblock;
fifth and sixth portions of the partition SADs correspond to even and odd parity pixel differences, respectively, for the odd field of the current macroblock; and
seventh and eighth portions of the partition SADs correspond to even and odd parity pixel differences, respectively, for a bottom frame portion of the current macroblock.

11. The method of claim 10, wherein the step of minimizing comprises:
determining a minimum costed SAD and associated motion vector for the top frame portion of the current macroblock pair by minimizing the first and second portions of the partition SADs and comparing the result to a running minimum costed SAD for the top frame portion;
determining a minimum costed SAD and associated motion vector for the even field of the current macroblock pair by minimizing the third and fourth portions of the partition SADs and comparing the result to a running minimum costed SAD for the even field;
determining a minimum costed SAD and associated motion vector for the odd field of the current macroblock pair by minimizing the fifth and sixth portions of the partition SADs and comparing the result to a running minimum costed SAD for the odd field; and
determining a minimum costed SAD and associated motion vector for the bottom frame portion of the current macroblock pair by minimizing the seventh and eighth portions of the partition SADs and comparing the result to a running minimum costed SAD for the bottom frame portion.

12. The method of claim 8, wherein the step of costing further comprises:
obtaining previous motion vectors from neighboring macroblock pairs in the current frame;
computing a median of the previous motion vectors; and
for each partition SAD of the partition SADs, computing a cost by multiplying the difference between a motion vector associated with the partition SAD and the median with a constant.

13. A video encoder, comprising:
a pre-processor for providing processed video data; and
a motion estimation sub-system having at least one full pel motion estimator (FPME), each of the at least one FPME comprising:
registers for storing an even field and an odd field of a current macroblock pair in a current frame in the processed video data;
first-in-first-out (FIFO) logic for storing a reference window of a reference frame in the processed video data;
costing logic for producing cost data; and
processing logic, coupled to the registers, the FIFO logic, and the costing logic, for generating common sums of absolute differences (SADs) for the current macroblock pair, generating SADs for partitions of the current macroblock pair from combinations of the common SADs, and costing and minimizing the SADs for the partitions.

14. The video encoder of claim 13, wherein the processing logic comprises:
common SAD modules for producing the common SADs;
partition SAD modules for producing the SADs for the partitions; and
compare modules for costing and minimizing the SADs for the partitions.

15. The video encoder of claim 14, wherein the common SAD modules comprise:
a first common SAD module for processing the even field of the current macroblock pair and an even field data of the reference window;
a second common SAD module for processing the even field of the current macroblock pair and an odd field data of the reference window;
a third common SAD module for processing the odd field of the current macroblock pair and the odd field data of the reference window; and
a fourth common SAD module for processing the odd field of the current macroblock pair and the even field data of the reference window.

16. The video encoder of claim 14, wherein the partition SAD modules comprise:
first and second partition SAD modules for producing even and odd parity partition SADs, respectively, for a top frame portion of the current macroblock pair;
third and fourth partition SAD modules for producing even and odd parity partition SADs, respectively, for the even field of the current macroblock pair;
fifth and sixth partition SAD modules for producing even and odd parity partition SADs, respectively, for the odd field of the current macroblock pair; and
seventh and eighth partition SAD modules for producing even and odd parity partition SADs, respectively, for a bottom frame portion of the current macroblock pair.

17. The video encoder of claim 14, wherein the compare modules comprise:
a first compare module for producing a minimum costed SAD and associated motion vector for the top frame portion of the current macroblock pair;
a second compare module for producing a minimum costed SAD and associated motion vector for the even field of the current macroblock pair;
a third compare module for producing a minimum costed SAD and associated motion vector for the odd field of the current macroblock pair; and
a fourth compare module for producing a minimum costed SAD and associated motion vector for the bottom frame portion of the current macroblock pair.

18. The video encoder of claim 13, wherein the processing logic comprises a first computation block and a second computation block.

19. The video encoder of claim 18, wherein the processing logic further comprises:
a first compare module for producing a minimum costed SAD and associated motion vector for a top frame portion of the current macroblock pair;
a second compare module for producing a minimum costed SAD and associated motion vector for the even field of the current macroblock pair;
a third compare module for producing a minimum costed SAD and associated motion vector for the odd field of the current macroblock pair; and
a fourth compare module for producing a minimum costed SAD and associated motion vector for a bottom frame portion of the current macroblock pair.

20. The video encoder of claim 13, wherein the processed video data comprises half horizontal resolution (HHR) video data.
